(19) United States
(12) Patent Application Publication
(10) Pub. No.: US 2006/0172836 A1
(43) Pub. Date: Aug. 3, 2006

(54) Guide for transmission device

(75) Inventors: Kaori Mori, Osaka (JP); Tatsuya Konishi, Osaka (JP); Junya Kurohata, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/304,377

(22) Filed: Dec. 15, 2005

(30) Foreign Application Priority Data
Jan. 18, 2005 (JP) 2005-010535

(51) Int. Cl. F16H 7/08; F16H 7/18

(52) U.S. Cl. 474/111; 474/140

(57) ABSTRACT

A guide for an engine timing chain comprises a shoe mounted on a guide body, and having opposed, chain-restricting, side walls integrally molded with a chain-contacting shoe bottom. Each wall comprise a low portion, and an outwardly stepped high portion. The height of the low portion less than the distance between the connecting pins of the chain and the chain-contacting surface of the shoe bottom. The height of the high portion, however, is greater than the distance between the connecting pins and the chain-contacting surface. The high portion of each wall is stepped outward sufficiently to provide a clearance between the end of a connecting pin and the inwardly facing side of the high portion when the adjacent outer link plate of the chain is in contact with the corresponding low portion. The height of the high portion, however is greater than the overall height of the timing chain.

### CROSS REFERENCE TO RELATED APPLICATION

This application claims priority on the basis of Japanese patent application No. 2005-010535, filed Jan. 18, 2005, the disclosure of which is hereby incorporated by reference.

### FIELD OF THE INVENTION

This invention relates to improvements in sliding contact guides for endless, flexible traveling transmission media, such as roller chains, silent chains, and the like, for transmitting rotation from a driving sprocket to one or more driven sprockets. Such transmission media are used, for example, in the timing transmission of an internal combustion engine. The guides can be fixed guides, or movable guides of the kind used, in cooperation with a tensioner, to control tension in the transmission medium.

### BACKGROUND OF THE INVENTION

A conventional movable guide, in the form of a pivotable tensioner lever, is illustrated in FIG. 10 and described in Japanese Patent Publication No. 3448122. The tensioner lever 500 including a guide body 520, and a shoe 510, mounted on the guide body and adapted for sliding contact with a traveling transmission chain.

As shown in FIG. 11, the shoe is formed with right and left, chain-restricting, side walls 511 which extend from the surface of the shoe 510 on which the chain slides. These side walls maintain the traveling line of the chain C, restrict snaking travel of the chain, and prevent the chain from disengaging from the guide.

The height of the side walls is such that a clearance is provided between the connecting pins of the chain and the chain-restricting side walls, so that contact between the pins and the side walls is avoided as the chain moves toward one or the other of the side walls. When an outer link plate of the chain contacts one of the side walls 511, the connecting pins extend over the side wall. As a result, the side walls allow the chain to travel in sliding relationship with the guide, and reliably prevent the chain from disengaging from the guide during normal operation.

With the conventional tensioner lever 500, however, it was possible for an engine timing chain to jump onto the chain-restricting side walls 511 occasionally as a result of backlash or fluttering of the chain on starting of the engine. The chain C can either ride on the chain-restricting side wall 511 as shown in FIG. 12, or straddle the chain-restricting side wall 511 as shown in FIG. 13. In either case, smooth sliding of the timing chain C cannot be continued.

A further problem with the conventional tensioner lever is that, the condition in which the timing chain C rides on, or straddles, the chain-restricting side wall 511 can also occur during assembly of the engine timing transmission. This condition cannot be recognized easily, either by visual inspection, or by means of sensors. If an engine is started with the timing chain in one of the conditions illustrated in FIGS. 12 and 13, the timing chain can ride over a chain-restricting side wall 511 and drop off the guide altogether, whereupon it can also disengage the sprockets of the timing transmission, causing engine failure. Even if the condition in which the chain is riding on, or straddling, a side wall is recognized, it is difficult to return the chain to the condition illustrated in FIG. 11.

This invention allows the irregular conditions of the kind illustrated in FIGS. 12 and 13 to be recognized easily during engine assembly, prevents these conditions from occurring during engine operation, and ensures smooth travel of the chain on a guide during ordinary engine operation.

### SUMMARY OF THE INVENTION

The transmission device in accordance with the invention comprises an endless, traveling, transmission chain comprising links articulably connected by connecting pins, and a chain guide in sliding engagement with the chain. The chain guide includes a shoe having a bottom wall in sliding engagement with the chain, and spaced, chain-restricting, side walls on opposite sides of the chain. The side walls and the bottom wall are molded as a unit, and each of the side walls comprises a low wall portion and a high wall portion. The low wall portion extends from the bottom wall of the shoe by a distance less than the distance by which a connecting pin of the chain is spaced from said bottom wall when a pair of links connected by the pin are both in engagement with the bottom wall. The high wall portion extends to a location spaced from the bottom wall by a distance greater than the distance by which a connecting pin of the chain is spaced from the bottom wall when a pair of links connected by the pin are both in engagement with the bottom wall, but less than the height of the chain. The low and high wall portions of each chain-restricting side wall are in stepped relationship, the high wall portion being disposed outward from the low wall portion by a distance sufficient to provide a clearance accommodating the connecting pins of the chain when the chain is in contact with the low wall portion.

The guide according to the invention allows a timing chain to travel smoothly in sliding contact with the guide, and prevents dropping off of the chain. Moreover, the height of the high wall portions of the guide is such that an irregular condition, as in FIGS. 12 and 13, can be recognized easily during engine assembly, so that the engine is not started while the timing chain is irregularly incorporated, and failure of the engine due to disengagement of the timing chain can be avoided.

Moreover, the invention inhibits improper installation of the timing chain because, in most cases, with a tensioner in place, the chain cannot be incorporated onto the guides of the timing transmission without relocating the tensioner.

### BRIEF DESCRIPTION OF THE DRAWINGS

FIG. 1 is a schematic front elevational view of the timing drive of an internal combustion engine, in which the timing chain is guided by a movable guide and a fixed guide, both being guides in accordance with the invention;

FIG. 2 is an exploded view of the movable guide of FIG. 1;

FIG. 3 is a cross-sectional view of the chain-engaging shoe of the movable guide of FIGS. 1 and 2, taken on section plane 3-3 in FIG. 2, and showing the relationship between a timing chain and the shoe;

FIG. 4 is a cross-sectional view corresponding to FIG. 3, and an enlargement of a portion thereof, illustrating a condition in which the timing chain has moved toward one side of the shoe;

FIG. 5(A) shows a chain layout in which the chain is properly incorporated into the timing transmission;

FIG. 5(B) shows a chain layout in which the chain is improperly incorporated into the timing transmission;

FIG. 6 is a partial cross-sectional view of a guide in accordance with a second embodiment of the invention, showing the relationship between the guide and a timing chain;

FIG. 7 is an exploded view of a movable guide in accordance with a third embodiment of the invention;

FIG. 8 is cross-sectional view of the chain-engaging shoe of the movable guide of FIG. 7, taken on section plane 8-8 in FIG. 7, and showing the relationship between a timing chain and the shoe;

FIG. 9(A) shows a chain layout in a fourth embodiment of the invention, in which the chain is properly incorporated into the timing transmission;

FIG. 9(B) shows a chain layout in the fourth embodiment, in which the chain is improperly incorporated into the timing transmission;

FIG. 10 is an exploded view of a conventional movable guide;

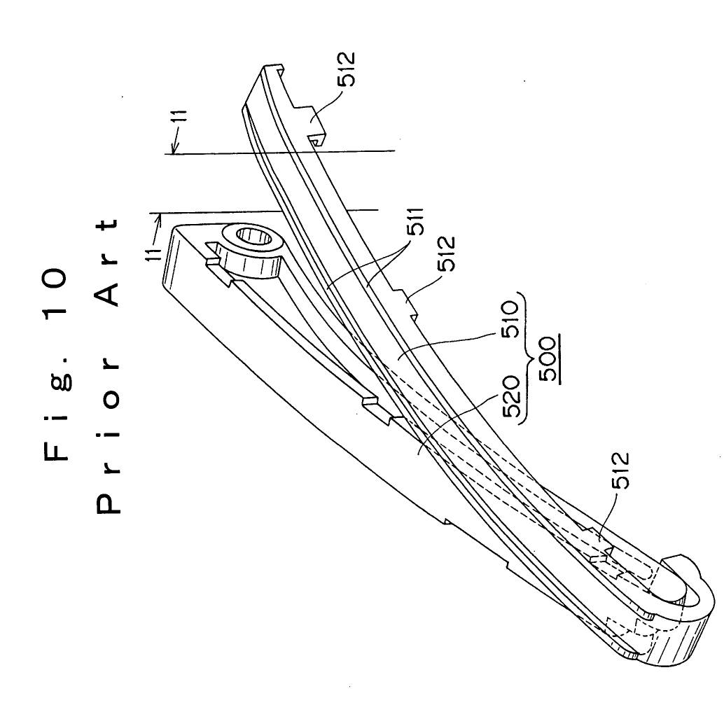

FIG. 11 is a cross-sectional view of the chain-engaging shoe of the movable guide of FIG. 10, taken on section plane 11-11 in FIG. 10, and showing the relationship between a timing chain and the shoe;

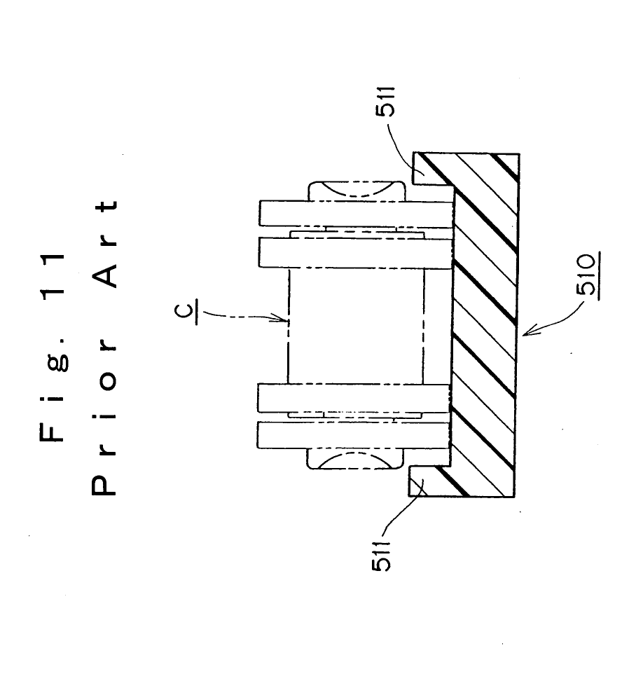

FIG. 12 is a cross-sectional view corresponding to FIG. 12, but showing a condition in which the timing chain rides on a chain-restricting side wall; and

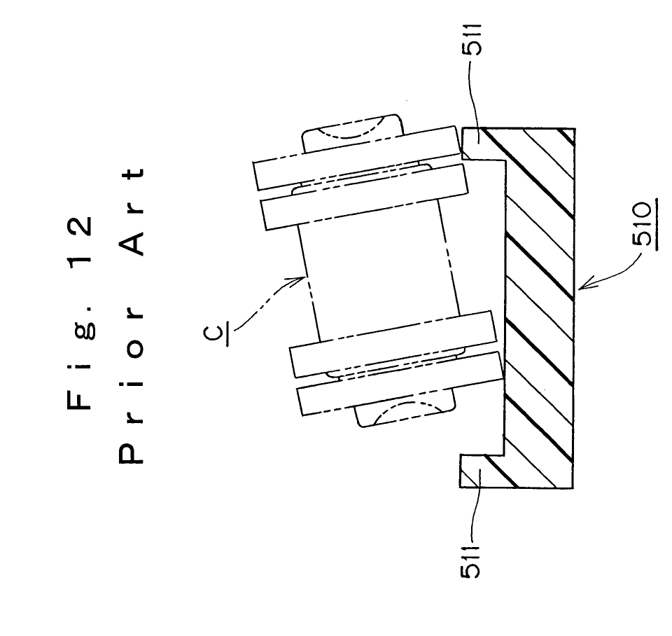

FIG. 13 is a cross-sectional view corresponding to FIGS. 11 and 12, but showing a condition in which the timing chain straddles the chain-restricting side wall.

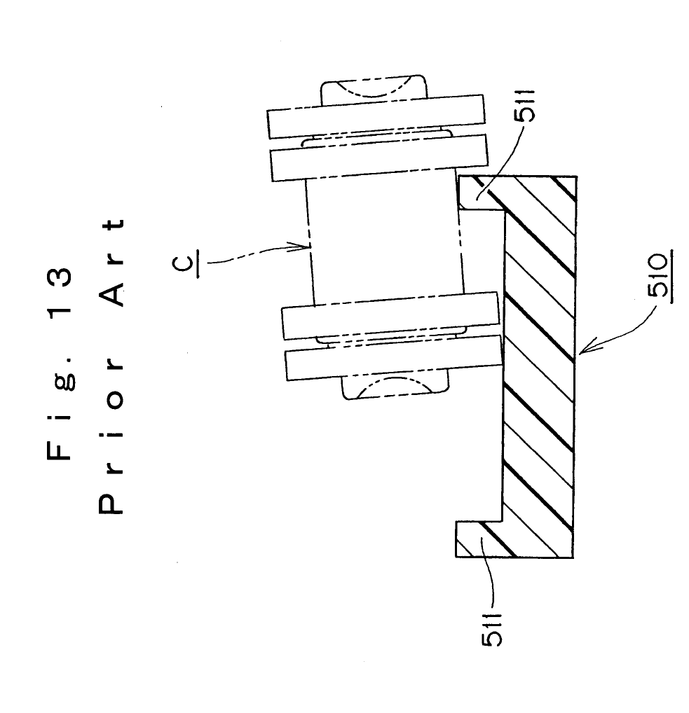

### DETAILED DESCRIPTION OF THE PREFERRED EMBODIMENTS

The invention will be described with reference to a movable guide used in cooperation with a tensioner to maintain tension in a chain. However, it should be understood that the invention is applicable as well to fixed chain guides.

The shoe of the guide according to the invention can be formed integrally with a guide body or as a separate element to be attached to the guide body. The shoe may be molded from a polymer resin material, preferably selected from a polyamide 6 resin, a polyamide 66 resin, a polyamide 46 resin, all aromatic resins, glass-fiber reinforced resins and the like, which preferably exhibit good wear resistance, and have self-lubricating properties.

The chain-restricting side walls can take various forms. For example, both side walls can be continuous along the entire length of the guide. Alternatively, the side walls can be discontinuous. In still another arrangement, one of the side walls can extend along a first part of the length of the guide, and the other side wall can extend along another part of the guide, with or without overlap.

The chain, which travels on the guide in sliding relationship with the chain-contacting surface of the bottom wall of the guide, can be any suitable transmission chain, such as roller chain, or a silent chain.

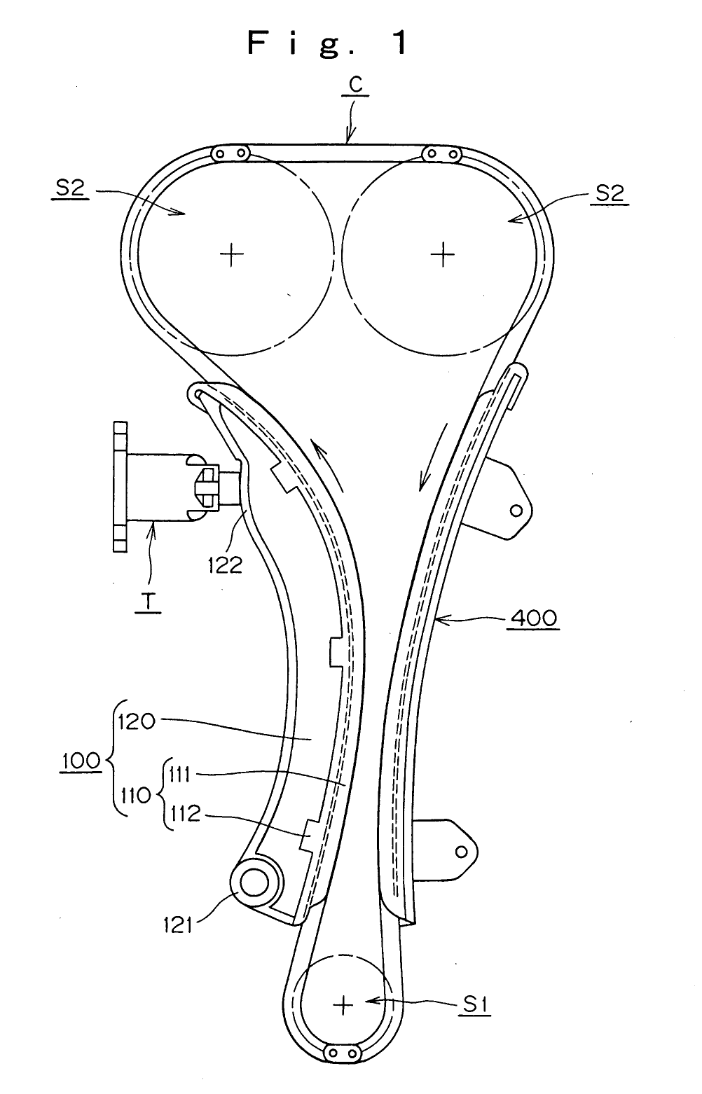

The movable guide 100, in FIG. 1, is attached to an engine block (not shown), and is in sliding contact with the slack side of an engine timing chain C, which in this case is a roller chain engaged with, and driven by, a crankshaft sprocket S1, and driving a pair of camshaft sprockets S2.

The guide is pivoted on a mounting pin (not shown) which extends through a boss 121 at one end of the guide, and urged into sliding contact with the chain by a tensioner T. The timing transmission also includes a fixed guide 400, with which the tension side of the chain is in sliding contact.

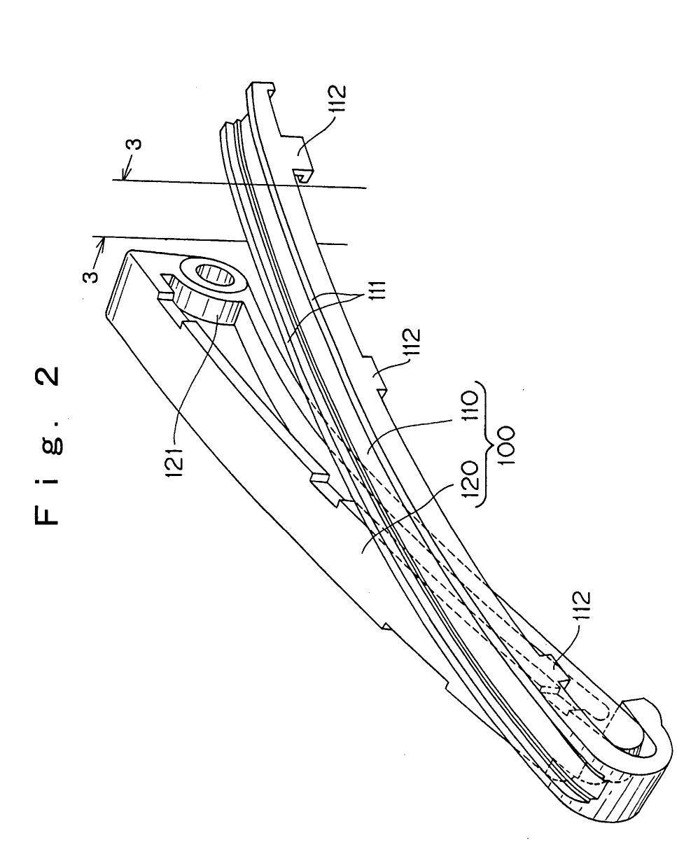

As shown in FIGS. 1 and 2, the movable guide 100 comprises a shoe 110 having a substantially arc-shaped chain-contacting surface on which timing chain C slides, and a guide body 120, on the back of the shoe 110. Both the shoe and the guide body are elongated in the direction of travel of the part of the chain which is in sliding contact with the shoe. Two chain-restricting side walls 111 extend along the entire length of the guide on opposite sides of the chain to restrict movement of the chain C, to prevent the chain C from dropping off the guide, and to ensure smooth sliding contact between the chain and the chain-contacting surface of the shoe. A pad portion 122, formed on the guide body, is abutted by the plunger of tensioner T, which applies proper tension to the chain through the movable guide, and prevents faulty operation that would otherwise result from excessive tensioning or loosening of the chain C. Hooks 112, formed on the shoe, secure the shoe to the guide body 120.

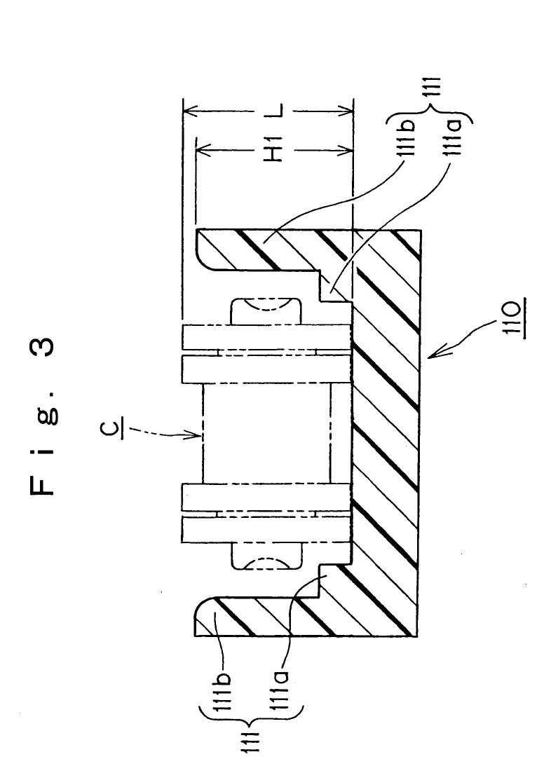

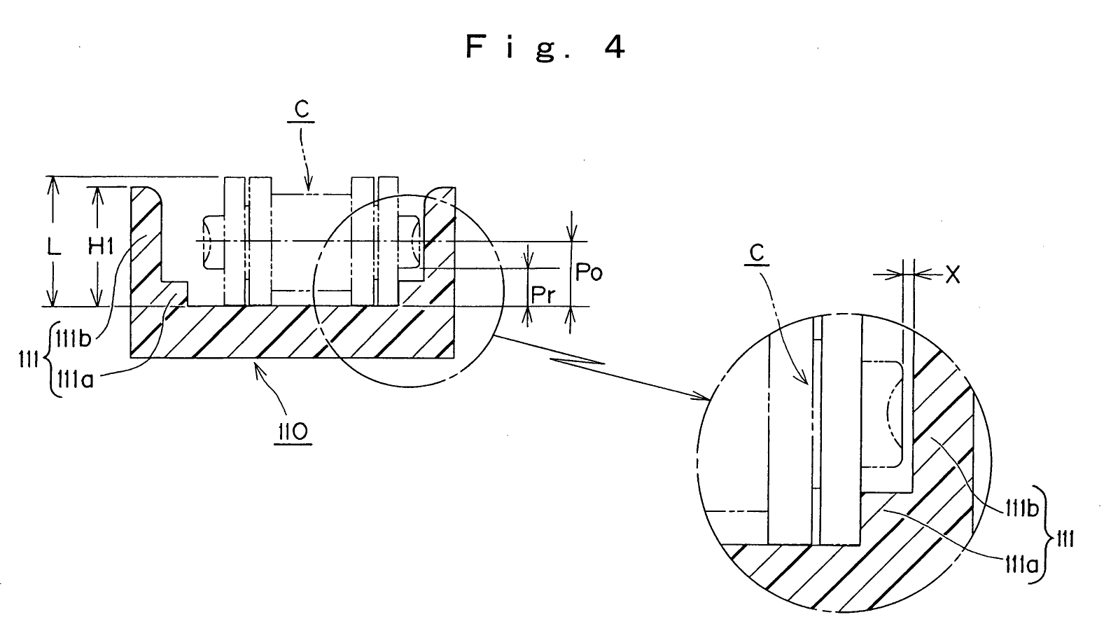

As shown in FIG. 3, each of said chain-restricting side walls 111 is molded as a unit with the bottom, or chain-contacting, portion of the shoe 110. Each of the side walls 11 comprises a low wall portion 111a and a high wall portion 111b. The high wall portion is disposed laterally outward relative to the low wall portion, forming a step as shown in FIG. 3. As illustrated in FIG. 4, the height Pr of the low wall portion, measured from the chain-contacting surface of the bottom portion of the shoe, is less than the distance Po, measured from the chain-contacting surface of the shoe to the connecting pin of chain C, when the links connected by the pin are in engagement with the chain-contacting surface. On the other hand, the height H1 of the high wall portion, is greater than distance Po, but preferably less than the total height L of the chain links. Making the height H1 slightly less than height L facilitates incorporation of the timing chain onto the guide.

As shown in FIG. 4, the high wall portion 111b of each chain-restricting side wall is stepped outward from the inwardly facing side of the corresponding low wall portion 111a by a distance greater than the distance by which the connecting pin projects laterally from the outermost link plate of the chain, leaving a minimum clearance X between the pin and the inwardly facing side of the high wall portion when an outermost link plate of the outer chain is in contact with the inwardly facing side of the low wall portion. The clearance X prevents contact between the end of the pin and the chain-restricting side wall, ensuring that the press-fit relationship between the pin and the outermost link plate of the chain will be maintained. At the same time, the lateral dimension of the step can be such that clearance X is sufficiently small that, in the event the chain tilts on the guide shoe, contact between the pin and the high portion 111b of the restricting wall prevents the chain from riding onto the step.

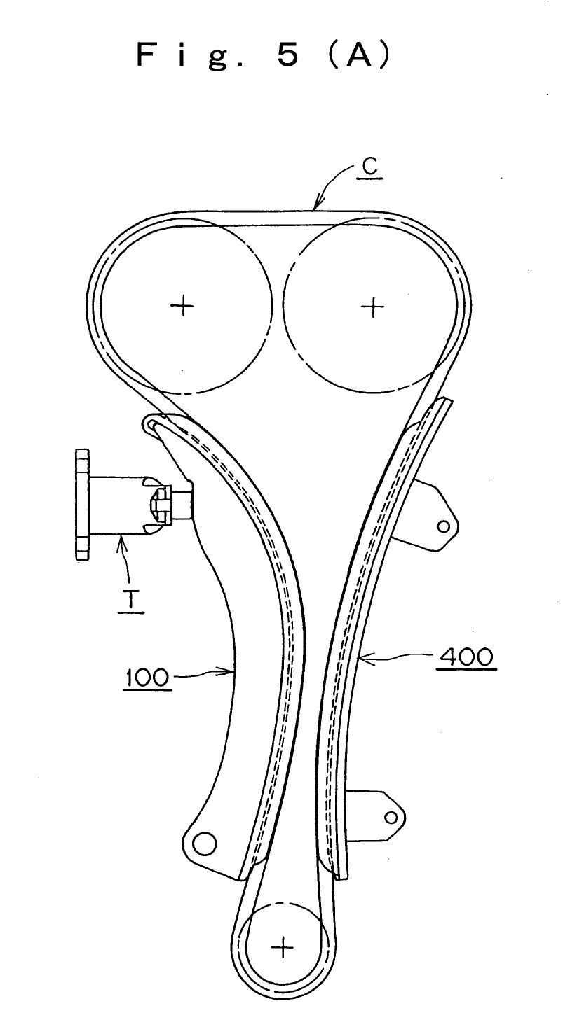

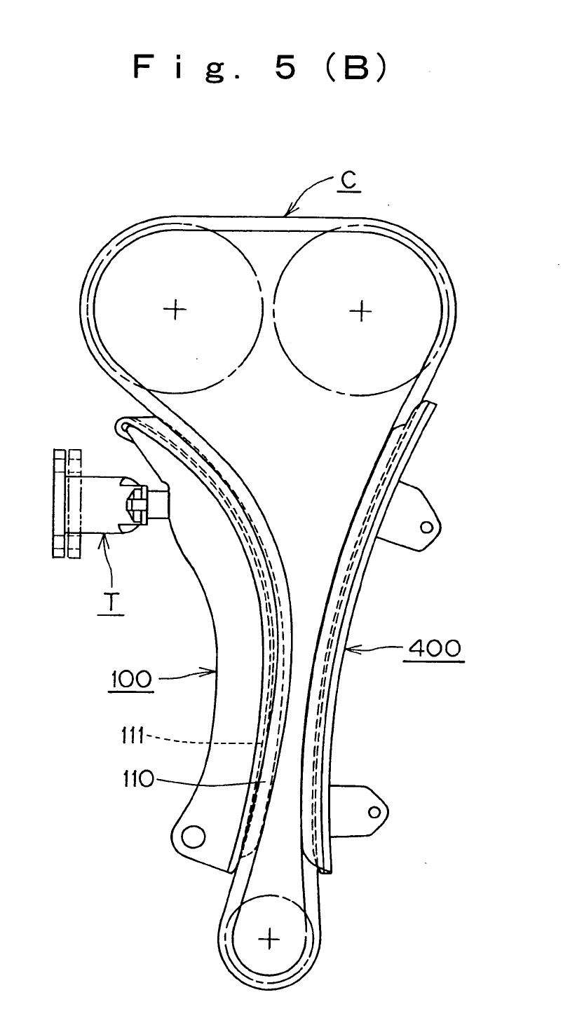

If the chain C is not properly incorporated onto the guide 100, the chain will ride on the chain-restricting side wall 111 of the shoe 110. As seen in FIG. 5(B), this condition can be readily recognized visually, and corrected. Furthermore, in most cases, because of the height of the chain-restricting side wall, improper incorporation of the chain onto the guide, as illustrated in FIG. 5(B) would require relocation of the tensioner T from its regular mounting position, shown by broken lines, to a position shown by solid lines. Consequently, in most cases where a tensioner is used in combination with a movable guide, the restricting wall height H1, will be sufficiently great that the chain C cannot be improperly incorporated on the guide, and erroneous assembly of the timing transmission can be reliably avoided.

For comparison with FIG. 5(B), which shows a chain improperly incorporated onto a movable guide, FIG. 5(A) shows the chain properly incorporated onto the guide.

The guide 100, as illustrated in FIG. 5(B), ensures that the timing chain C travels smoothly in sliding contact with the guide, and prevents the chain from dropping off the guide. Furthermore, in the assembly of the timing transmission improper incorporation of the chain onto the guide can be easily recognized and corrected, so that damage, which would otherwise occur upon engine start-up, can be reliably avoided.

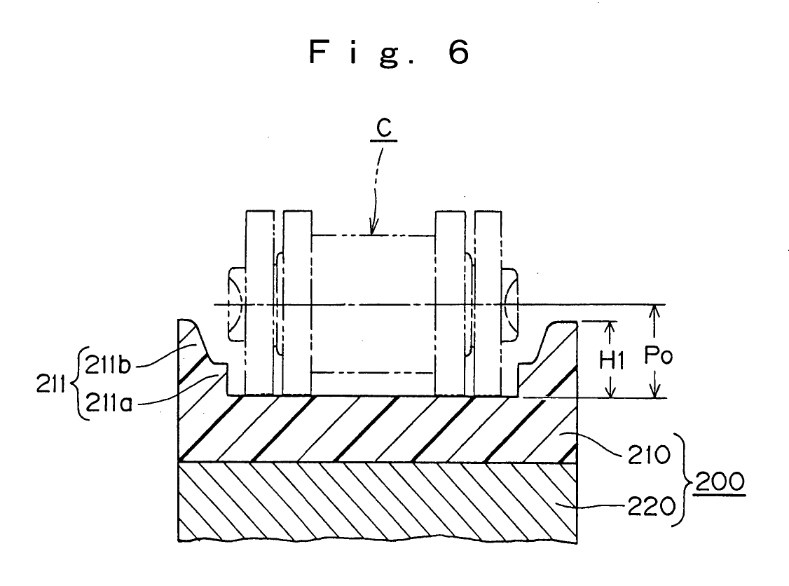

In the second embodiment, illustrated in FIG. 6, a shoe 210, incorporated onto a guide body 220 of guide 200, has chain restricting side walls 211, which have a cross-section differing from that of the chain-restricting side walls of the first embodiment. In this case, the height H1 of the high wall portion 211b is greater than the distance from the chain-contacting surface of the shoe to the connecting pin, but less than the distance Po, from the chain-contacting surface of the shoe to the centerline of the pin. The inwardly facing surface of the high wall portion is also beveled. In this embodiment, incorporation of the timing chain C onto the guide during the incorporation thereof is facilitated, and easier than in the case of the first example. However, erroneous incorporation of the chain onto the guide can be readily recognized visually, as in the case of the first embodiment.

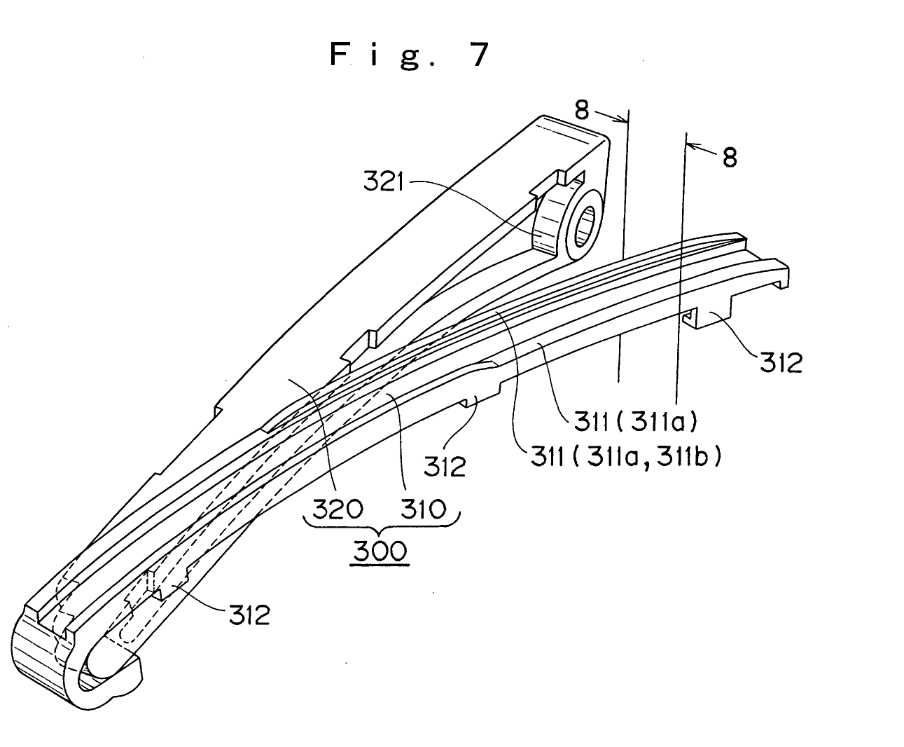

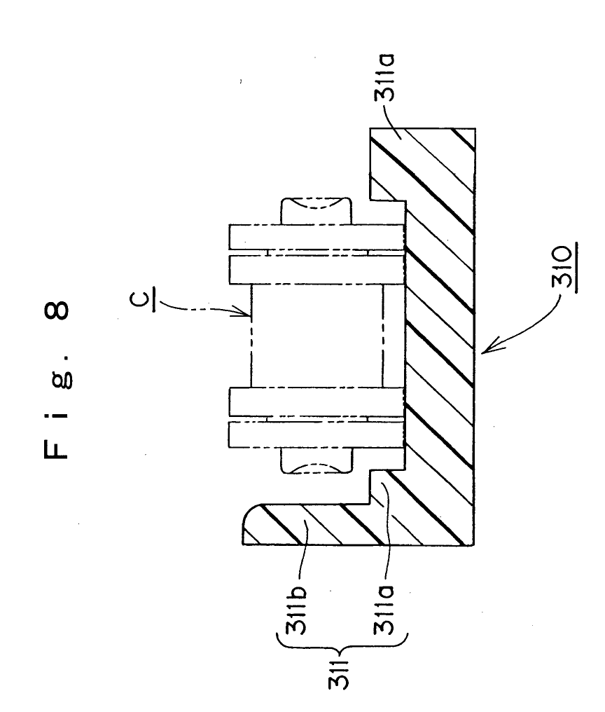

FIGS. 7 and 8 illustrate a third embodiment in accordance with the invention, in which a movable guide 300 comprises a shoe 310 having a substantially arc-shaped chain-contacting surface and a guide body 320 supporting the shoe, having a mounting hole in a boss 321, for receiving an engine block-mounted pivoting pin (not shown). The shoe is secured to the guide body by hooks 312, and has right and left, chain-restricting side walls 311. As shown in FIGS. 7 and 8, the left side wall has a low wall portion 311a and a high portion 311b, in stepped relationship as in the first embodiment. However, the high wall portion extends along only a part of the length of the shoe, from the entry end (adjacent the pivot) to an intermediate location. The low side wall portion, however extends along substantially the full length of the shoe. The right side wall similarly has a low wall portion 311a and a high wall portion 311b, having a cross-sectional shape (not shown) corresponding to that of the left side wall. The low wall portion extends substantially the full length of the shoe, but the high wall portion extends from an intermediate location to the exit end of the guide. The high wall portions of the left and right walls can overlap, as shown in FIG. 7.

At the locations at which the high wall portions are situated above, and in stepped relationship with, the low wall portions, the cross-sections and dimensions are similar to the cross-sections and dimensions of the chain-restricting walls in FIG. 3.

The guide 300 exhibits all of the advantages of the guide according to the first embodiment, especially in that it effectively allows smooth travel of the timing chain, prevents the timing chain from dropping off the guide and causes irregular incorporation of the chain on the guide to be easily recognized by visual inspection. Additionally, since the chain-restricting walls have partially cut out high wall portions alternately disposed on the right and left side sides of the shoe, the timing chain C can be easily incorporated onto the guide.

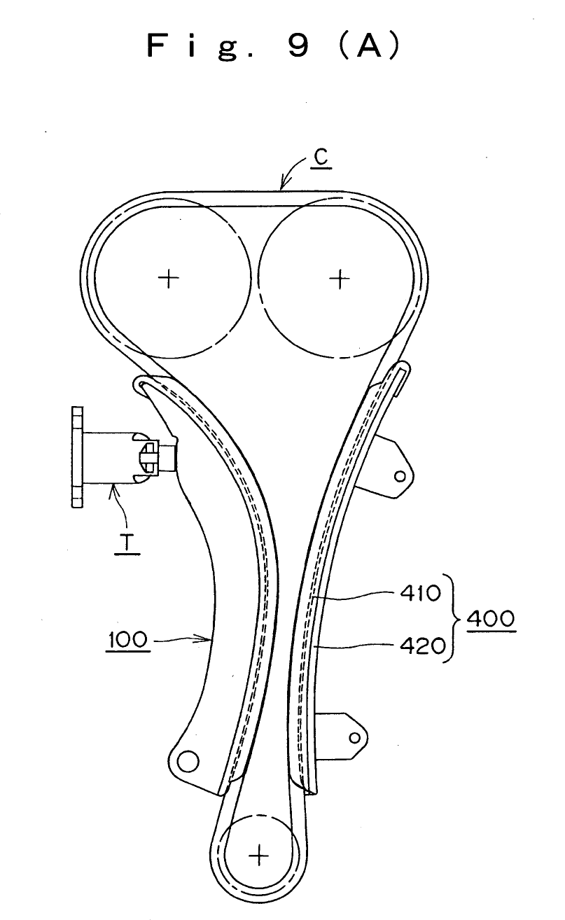

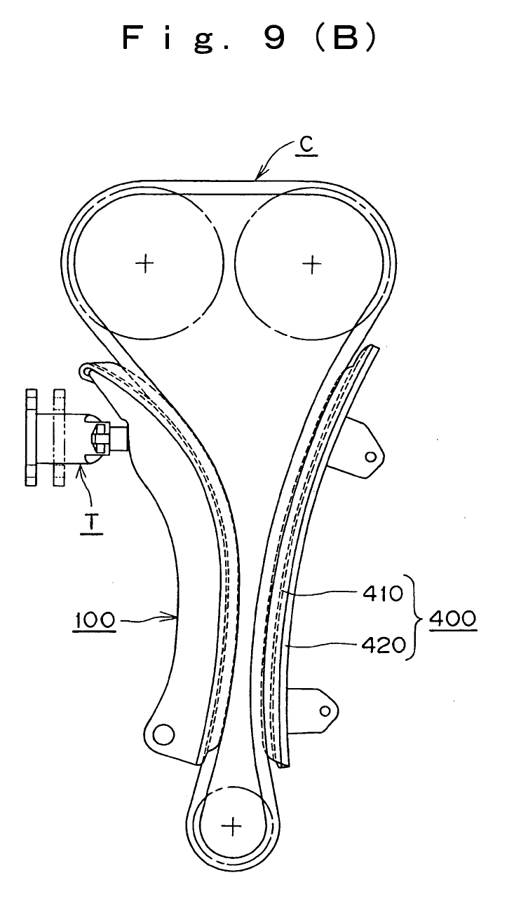

FIGS. 9(A) and 9(B) show, respectively, proper and improper incorporation of a timing chain C onto a fixed guide 400. The guide 400 comprises a shoe 410 having a substantially arc-shaped chain-contacting surface on which timing chain C slides, and a shoe-supporting guide body 420 on the back of the shoe. The shoe 410 has right and left, chain-restricting side walls, similar to those of the movable guide of FIG. 3. These side walls extend-along substantially the entire length of the guide, prevent the chain from dropping off the guide, and ensure smooth travel of the chain in sliding contact with the guide.

Therefore, if the chain C is improperly incorporated onto the guide, as shown in FIG. 9(B), the chain rides on a chain-restricting side wall of the shoe 410, and this condition can be recognized visually without difficulty. Furthermore, improper installation of the chain on the fixed guide 400 results in a shortening of the slack side of the chain, which tends to push the movable guide 100 outward. Consequently, if the chain is improperly incorporated onto the fixed guide during assembly of the timing transmission, the tensioner T would need to be relocated from its regular mounting position, as shown by broken lines to a mounting position shown by solid lines. As a result, it is difficult to install the timing chain C in a condition in which it is improperly incorporated on one or both of the guides, and the erroneous incorporation depicted in FIG. 9 can be reliably avoided.

As with the embodiments previously described, the fixed guide in accordance with the fourth embodiment of the invention ensures smooth travel of the timing chain, prevents the chain from dropping off the guide, and enables improper incorporation of the chain onto the guide to be readily recognized by visual inspection, so that the engine is not started while the timing chain is improperly installed.

What is claimed is:

1. A transmission device comprising:
an endless, traveling, transmission chain comprising links articulably connected by connecting pins;
a chain guide including a shoe having a bottom wall in sliding engagement with said transmission chain, and spaced, chain-restricting, side walls on opposite sides of the chain, the side walls and said bottom wall being molded as a unit;
each of said chain-restricting side walls comprising a low wall portion and a high wall portion;
the low wall portion extending from said bottom wall of the shoe by a distance less than the distance by which a connecting pin of the chain is spaced from said bottom wall when a pair of links connected by said pin are both in engagement with said bottom wall; and
the high wall portion extending to a location spaced from said bottom wall by a distance greater than the distance by which a connecting pin of the chain is spaced from said bottom wall when a pair of links connected by said pin are both in engagement with said bottom wall, but less than the height of the chain; and
the low and high wall portions of each chain-restricting side wall being in stepped relationship, the high wall portion being disposed outward from the low wall portion by a distance sufficient to provide a clearance accommodating the connecting pins of the chain when the chain is in contact with the low wall portion.
